(19) United States
(12) Patent Application Publication
(10) Pub. No.: US 2026/0153836 A1
(43) Pub. Date: Jun. 4, 2026

(54) HOLOGRAPHIC DISPLAY APPARATUS AND METHOD FOR PROVIDING ENHANCED VIEWING ZONE

(71) Applicant: ELECTRONICS AND TELECOMMUNICATIONS RESEARCH INSTITUTE, Daejeon (KR)

(72) Inventor: Hyun Eui KIM, Daejeon (KR)

(73) Assignee: ELECTRONICS AND TELECOMMUNICATIONS RESEARCH INSTITUTE, Daejeon (KR)

(21) Appl. No.: 19/404,248

(22) Filed: Dec. 1, 2025

(30) Foreign Application Priority Data
Nov. 29, 2024 (KR) 10-2024-0175301

(51) Int. Cl. G03H 1/22

(52) U.S. Cl. CPC G03H 1/2202; G03H 1/2294; G03H 2223/50; G03H 2226/02

(57) ABSTRACT

An embodiment relates to a holographic display apparatus with an enhanced viewing zone, which is characterized by comprising a spatial light modulator configured to modulate light incident from a light source into a light wave corresponding to a hologram; an optical system configured to perform a Fourier transform on the light wave from the spatial light modulator to generate a Fourier-transformed light wave and to propagate the light wave; and a beam splitting element configured to split the light wave propagated from the optical system to expand a viewing zone of a holographic display.

### CROSS-REFERENCE TO RELATED APPLICATION

This application claims priority to Korean Patent Application No. 10-2024-0175301, filed on Nov. 29, 2024, the entirety of which is incorporated herein by reference for all purposes.

### TECHNICAL FIELD

An embodiment relates to a holographic display apparatus and method for providing an enhanced viewing zone.

### BACKGROUND

Holographic display technology is considered a key tool for implementing augmented reality (AR). However, the Spatial Bandwidth Product (SBP) of a Spatial Light Modulator (SLM), one of the key components of a holographic display system, is limited in its ability to meet the requirements for implementing a commercial display. As a result, the size, viewing angle, and viewing zone of the 3D image provided by the display are limited, which degrades the user's sense of immersion. To solve this performance problem, new approaches and technologies are needed.

As new approaches, various multiplexing methods have been proposed. For example, there is a spatial multiplexing method that uses multiple SLMs to display different viewpoint information in different regions. Furthermore, there is also a time-division multiplexing method that controls the output direction of each image frame by utilizing an optical scanner while rapidly switching images.

However, conventional methods still have limitations such as complex system configurations and high costs, which constrain their practicality.

Background art relevant to an embodiment is disclosed in Korean Patent Registration No. 10-2257249 (May 28, 2021).

### SUMMARY

An object of an embodiment is to solve the problems described above by providing a holographic display apparatus and method for providing an enhanced viewing zone, which may expand the viewing zone of a holographic display.

A holographic display apparatus with an enhanced viewing zone according to an embodiment comprises a spatial light modulator configured to modulate light incident from a light source into a light wave corresponding to a hologram, an optical system configured to perform a Fourier transform on the light wave from the spatial light modulator to generate a Fourier-transformed light wave and to propagate the light wave, and a beam splitting element configured to split the light wave propagated from the optical system to expand the viewing zone of a holographic display.

According to the embodiment, the optical system may include a first lens and a second lens, wherein the first lens is positioned adjacently after the spatial light modulator in an optical path, and the second lens is positioned to be spaced apart from the first lens by the focal length of the first lens.

According to the embodiment, the beam splitting element may be positioned adjacently after the second lens in the optical path.

According to the embodiment, the apparatus may further comprise a processor for providing Computer-Generated Holography (CGH) data for representing the hologram to the spatial light modulator, wherein the processor, based on the positional difference in the viewing zone caused by the chromatic aberration of the beam splitting element, is configured to limit the hologram display area of the spatial light modulator or to adjust the position of the hologram display area.

According to the embodiment, the processor may measure the light wave intensity for each local area of the entire viewing zone of the holographic display and, based on the light wave intensity of each local area, adjust input image brightness information during hologram generation or adjust the intensity of the light source during hologram display.

According to the embodiment, the apparatus may further comprise a pupil tracking unit for tracking the position of a user's pupil, wherein the processor, based on the size and position of the user's pupil tracked by the pupil tracking unit, is configured to limit the hologram display area of the spatial light modulator or to adjust the position of the hologram display area.

According to the embodiment, the processor may infer an overlap area of a wavelength-specific viewing zone in the viewing zone of the holographic display and limit a hologram display area for each wavelength on the spatial light modulator corresponding to the overlap area.

A holographic display apparatus with an enhanced viewing zone according to another embodiment comprises a first image providing apparatus configured to modulate light of a first wavelength into a first light wave corresponding to a hologram, performing a Fourier transform on the first light wave, and splitting and outputting the Fourier-transformed first light wave; a second image providing apparatus configured to modulate light of a second wavelength into a second light wave corresponding to a hologram, performing a Fourier transform on the second light wave, and splitting and outputting the Fourier-transformed second light wave; a third image providing apparatus configured to modulate light of a third wavelength into a third light wave corresponding to a hologram, performing a Fourier transform on the third light wave, and splitting and outputting the Fourier-transformed third light wave; and a beam combining unit configured to combine and output the first light wave output from the first image providing apparatus, the second light wave output from the second image providing apparatus, and the third light wave output from the third image providing apparatus, wherein the beam combining unit comprises a trichroic prism, and each of the first, second, and third image providing apparatuses comprises: a spatial light modulator configured to modulate the corresponding light emitted from the corresponding light source into a light wave corresponding to a hologram; an optical system configured to perform a Fourier transform on the light wave and propagating it; and a beam splitting element configured to split the light wave propagated from the optical system to expand the viewing angle of the holographic display.

According to another embodiment, the beam combining unit may be disposed adjacent to the beam splitting element of each of the first, second, and third image providing apparatuses.

The holographic display apparatus and a method for providing an enhanced viewing zone according to the present disclosure have an effect of providing a user with a large 3D image size, a wide viewing angle, and a wide viewing zone even with the limited spatial bandwidth of a spatial light modulator (SLM) by splitting a light wave using a beam splitting element.

The holographic display apparatus and method for providing an enhanced viewing zone according to the present disclosure have an effect of enabling effective correction of image distortion caused by chromatic aberration, alignment errors, or the like, by limiting the hologram display area of the spatial light modulator and shifting the position of the hologram display area, which makes it possible to achieve color viewing zone registration as well as avoid crosstalk due to viewing zone overlap.

The holographic display apparatus and method for providing an enhanced viewing zone according to the present disclosure have an effect of providing a user with superior visual quality and a realistic 3D visual experience, and maximizing the performance of the system through the efficient utilization of the optical structure.

### BRIEF DESCRIPTION OF THE DRAWINGS

FIG. 1 is a diagram illustrating a holographic display apparatus.

FIG. 2 is a diagram illustrating a holographic display apparatus with an enhanced viewing zone according to the embodiment.

FIG. 3 is a diagram illustrating a holographic display apparatus with an enhanced viewing zone according another embodiment.

FIG. 4 is an exemplary diagram illustrating color dispersion of a beam splitting element according to the embodiment.

FIG. 5 is a diagram illustrating a holographic display apparatus with an enhanced viewing zone according to still another embodiment.

### DETAILED DESCRIPTION OF THE INVENTION

Hereinafter, exemplary embodiments of a holographic display apparatus and method for providing an enhanced viewing zone according to an embodiment will be described with reference to the accompanying drawings. In this process, the thickness of lines or the size of components shown in the drawings may be exaggerated for clarity and convenience of description. Furthermore, the terms described below are defined in consideration of their functions in an embodiment, and their meanings may vary according to the intent of a user or operator, or according to custom. Therefore, the definitions of these terms should be based on the content throughout this specification.

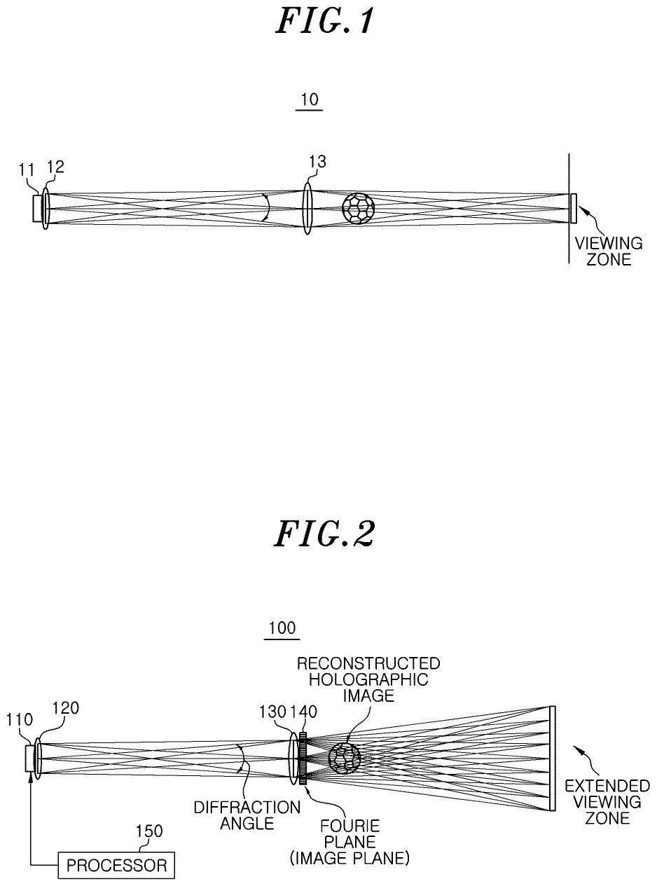

FIG. 1 is a diagram illustrating a holographic display apparatus.

Referring to FIG. 1, in a holographic display apparatus 10, the Fourier plane of a spatial light modulator (SLM) 11 is located inside a second lens 13, and it reproduces a reconstructed holographic image on depth planes before and after the Fourier plane. Herein, the viewing zone is formed by the light wave modulated by the spatial light modulator 11 being projected by the second lens 13, and while the size of the holographic image (reconstructed holographic image) is affected by diffraction characteristics according to wavelength, the viewing zone size is formed in the same area and position regardless of wavelength.

Due to specifications such as the size and pixel pitch of the spatial light modulator 11, the size, viewing angle, and viewing zone of the reconstructed holographic image reproduced by the holographic display are limited, causing a phenomenon in which the user's sense of immersion is degraded.

Accordingly, the embodiment proposes a technology that may overcome the narrow viewing angle caused by the spatial bandwidth limitation of a spatial light modulator.

The embodiment introduces an effective method for expanding the viewing zone in a axial direction, thereby making it possible to provide a user with a realistic and rich 3D image over a wider viewing range.

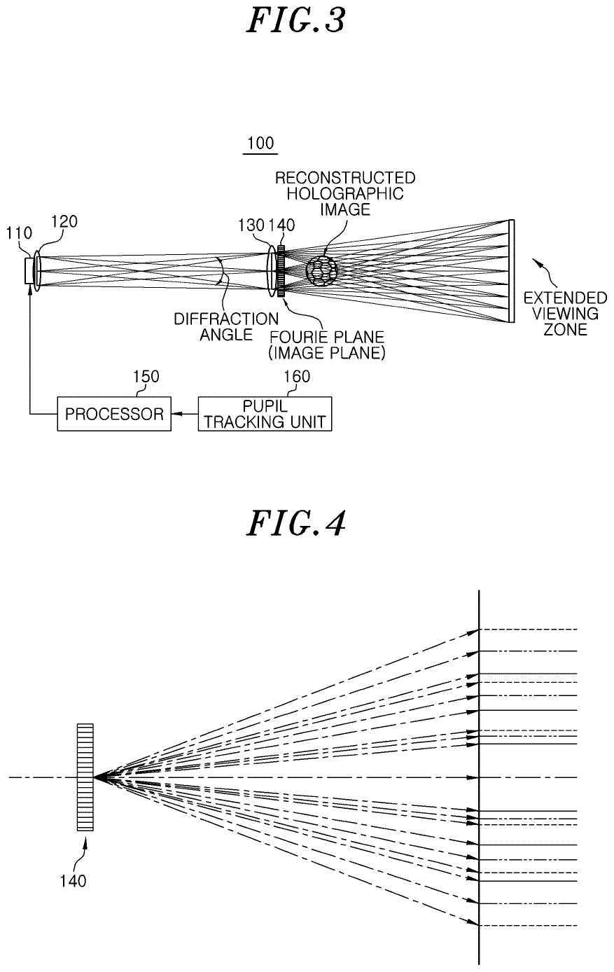

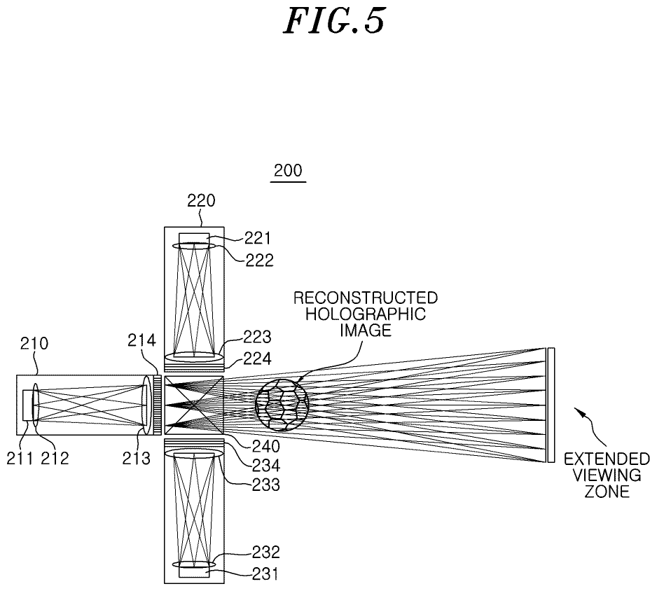

FIG. 2 is a diagram illustrating a holographic display apparatus with an enhanced viewing zone according to the embodiment, FIG. 3 is a diagram illustrating a holographic display apparatus with an enhanced viewing zone according to another embodiment, and FIG. 4 is an exemplary diagram illustrating color dispersion of a beam splitting element according to the embodiment.

Referring to FIGS. 2 and 3, a holographic display apparatus 100 with an enhanced viewing zone according to the embodiments may include a spatial light modulator (SLM) 110, an optical system 120 and 130, and a beam splitting element 140.

According to the embodiment, the spatial light modulator 110 may be a hologram display element and may modulate a light wave transmitted from a coherent light source into an arbitrary wavefront. Here, ‘hologram’ may be used to mean the same thing as ‘hologram pattern’. The image split and output by the beam splitting element 140 may be a reconstructed holographic image. The reconstructed holographic image may have the same meaning as a reconstructed holographic 3D image.

The spatial light modulator 110 may vary the hologram pattern displayed on each pixel under the control of a processor 150.

The spatial light modulator 110 may display (or form) a hologram pattern based on a hologram data signal, for example, a computer-generated hologram (CGH) data signal, provided from the processor 150. Incident light emitted from a light source and entering the spatial light modulator 110 is diffracted by the hologram pattern displayed on the screen of the spatial light modulator 110, and as a result of being diffracted by the hologram pattern formed on the spatial light modulator 110, a reconstructed holographic image having a sense of depth may be generated. The reconstructed holographic image may have the same meaning as a 3D image reconstructed from a hologram.

The spatial light modulator 110 may be any of a phase modulator capable of performing only phase modulation, an amplitude modulator capable of performing only amplitude modulation, or a complex amplitude modulator capable of performing both phase and amplitude modulation. For example, the spatial light modulator 110 may be a liquid crystal on silicon (LCoS), a digital micromirror device (DMD), or a semiconductor modulator.

The optical system 120 and 130 may perform a Fourier transform on the light wave modulated by the spatial light modulator 110.

The optical system 120 and 130 may include a first lens 120 and a second lens 130.

The first lens 120 and the second lens 130 may perform a Fourier transform on the hologram reproduced by the spatial light modulator 110.

The optical Fourier plane by the first lens 120 and the second lens 130 may be located in the same planar space as the second lens 130.

The first lens 120 may be configured to be positioned adjacent to the spatial light modulator 110, and the second lens 130 may be configured to be positioned at a point spaced apart from the first lens by the focal length (f) of the first lens 120. As an example, FIG. 2 illustrates a case where the first lens 120 is positioned after the spatial light modulator 110 in the optical path.

On the other hand, it is also possible for the first lens 120 to be positioned before the spatial light modulator 110 in the optical path. Herein, if the first lens 120 is positioned before the spatial light modulator 110 in the optical path, the focal length f1 of the first lens 120 may be set as f1=f2+d1. Here, d1 refers to the distance between the first lens 120 and the spatial light modulator 110, and f2 may refer to the distance between the spatial light modulator 110 and the second lens 130, which is the focal length of the second lens 130.

The beam splitting element 140 may split the light wave propagated from the optical system 120 and 130 to expand the viewing zone of the holographic display.

The beam splitting element 140 may expand the space in which a holographic image may be observed, that is, the viewing zone. For this purpose, the beam splitting element 140 may be positioned adjacent to the second lens 130 in the optical path.

If the beam splitting element 140 is disposed adjacent to the second lens 130, it may split the light to expand the viewing angle. The beam splitting element 140 may expand the viewing zone by splitting and outputting the hologram signal from the second lens 130. The beam splitting element 140 may split and output the hologram signal from the second lens 130 at multiple order angles. Then, the viewing zone may be expanded.

The beam splitting element 140 may be implemented, for example, as a Volume Holographic Optical Element (VHOE) made of a polymer material, a meta-element, or a diffraction element fabricated by a surface relief method.

Hereinafter, a case where the beam splitting element 140 is a diffraction grating made by a surface relief method will be described as one application example.

Since a diffraction grating splits and outputs an input signal at multiple order angles according to its period, it may generate a carrier wave in each order direction for the input signal. Therefore, if a diffraction grating is applied as the beam splitting element 140, a light wave transmitted from the spatial light modulator 110 may pass through the diffraction grating and converge at respective planar positions on a viewing zone plane to form the viewing zone. The viewing zone may be expanded by setting the period of the diffraction grating such that the viewing zones of respective orders are continuous.

However, since a conventional diffraction grating is not a beam splitting element 140 with ideal characteristics, in the case of a color imaging structure, a problem may occur where the viewing zone positions of each color on the viewing zone plane do not register because the output angle differs depending on the wavelength input to the diffraction grating, even for the same order. Furthermore, since the intensity of the light wave output from the diffraction grating decreases as the diffraction order increases, the viewing zone expansion range is limited, and the intensity of the signal transmitted to each order may be non-uniform.

Therefore, the beam splitting element 140 splits the light wave at a wide angle to secure the widest possible viewing zone, and the split light waves should have uniform intensity. Furthermore, for color imaging, the beam splitting element 140 must split the light wave at the same angle and with the same intensity over a broadband wavelength range including the RGB colors of visible light.

To this end, the holographic display apparatus 100 with an enhanced viewing zone may further include a processor 150.

The processor 150 may provide Computer-Generated Holography (CGH) data for representing the hologram to the spatial light modulator 110.

The processor 150 may, based on the positional difference in the viewing zone caused by the chromatic aberration of the beam splitting element 140, limit the hologram display area of the spatial light modulator 110 or adjust the position of the hologram display area.

The holographic display apparatus 100 is an apparatus for optically reconstructing a Fourier hologram, and band-limited region of the spatial light modulator 110, which is in an optical Fourier Transform (OFT) relationship, has a correlation with the respective carrier wave direction of the light wave output at the Fourier plane, which is the image plane.

Therefore, the processor 150 may limit the hologram display area (spatial band) of the spatial light modulator 110 or adjust the position of the hologram display area.

As such, by limiting the hologram display area of the spatial light modulator 110 or adjusting the position of the hologram display area, the processor 150 may set the viewing zone to an arbitrary size and position in the light wave region reaching the viewing zone plane, and thereby correct the mismatch of the color viewing zones.

Meanwhile, a beam splitting element 140 such as a diffraction element has a limitation in that it does not have a uniform intensity output in each split direction.

To solve this, the processor 150 may measure the light wave intensity for each local area of the entire viewing zone of the holographic display and, based on the light wave intensity of each local area, adjust input image brightness information during hologram generation or adjust the intensity of the light source during hologram display. At this time, the processor 150 may compare the light wave intensity of each local area, calculate a relative light wave intensity ratio for each local area, and based on the relative light wave intensity ratio for each local area, adjust the brightness of the image to be output during hologram calculation or adjust the output intensity of the input light source.

The processor 150 may adjust the brightness of the input image based on the relative light wave intensity ratio for each viewing zone during hologram calculation, or adjust the intensity of the input light source.

Meanwhile, if the light wave is split by the beam splitting element 140, it may extend outside the viewing zone of the holographic display. In such a case, the processor 150 may adjust the intensity of the light source according to the position of the user's pupil.

To this end, the holographic display apparatus 100 with an enhanced viewing zone may further include a pupil tracking unit 160 as shown in FIG. 3.

The pupil tracking unit 160 tracks the size and position of the user's pupil.

Viewing zone expansion through light splitting by the beam splitting element 140 provides a wide field of view, but since each viewing zone area has a structure in which single viewpoint information is replicated and repeated, it may deliver distorted parallax information at positions other than a specific viewing zone position.

The pupil tracking unit 160 may track the size and position of the user's pupil and transmit it to the processor 150.

In the case of parallax distortion due to repeated viewing zones, the problem may be solved by generating a hologram with an appropriate parallax corresponding to the tracked size and position of the user's pupil and displaying it on the spatial light modulator 110 via the processor 150.

A beam splitting element 140 such as a diffraction grating may cause irregular chromatic aberration as shown in FIG. 4.

To solve this, the processor 150 may, based on the size and position of the user's pupil tracked by the pupil tracking unit 160, limit the hologram display area of the spatial light modulator 110 or adjust the position of the hologram display area. At this time, the processor 150 may numerically infer the overlap area of wavelengths in the viewing zone of the holographic display and limit the hologram display area of the spatial light modulator 110 corresponding to the overlap area.

By adjusting the hologram display area and position based on the size and position of the user's pupil in this manner, the mismatch of each color viewing zone may be corrected.

Assuming that a non-optimized diffraction grating is applied as the beam splitting element 140, the red wavelength has the largest diffraction characteristic, and the angular difference between orders is larger than for other wavelengths. Therefore, the diffraction grating period may be designed so that the viewing zones are continuous on the viewing zone plane based on the red wavelength, considering the unit viewing zone size.

However, this causes the angle between orders of different wavelengths to narrow, resulting in viewing zone overlap between adjacent orders, and crosstalk may occur if the pupil is located in this overlapping area. For example, if continuous viewing zones are created based on the red wavelength, the blue wavelength may form overlapping viewing zones (overlap area). Crosstalk or the like may occur in the overlap area.

To avoid crosstalk, the processor 150 may limit the hologram display area of the spatial light modulator 110 in the overlapping region to transmit only a single-order signal.

The processor 150 may infer the overlap area in the blue wavelength viewing zone using the ratio of the blue wavelength to the red wavelength. Considering the ratio between the two wavelengths, to avoid the overlap area, the unit viewing zone size in the optical system 120 and 130 may be more than twice the maximum size of the pupil.

FIG. 5 is a diagram illustrating a holographic display apparatus with an enhanced viewing zone according to the still another embodiment.

Referring to FIG. 5, according to the still another embodiment, a holographic display apparatus 200 with an enhanced viewing zone may include a first image providing apparatus 210, a second image providing apparatus 220, a third image providing apparatus 230, and a beam combining unit 240.

The first image providing apparatus 210 may modulate light of a first wavelength into a first light wave corresponding to a hologram, perform a Fourier transform on the first light wave, and split and output the Fourier-transformed first light wave.

The second image providing apparatus 220 may modulate light of a second wavelength into a second light wave corresponding to a hologram, perform a Fourier transform on the second light wave, and split and output the Fourier-transformed second light wave.

The third image providing apparatus 230 may modulate light of a third wavelength into a third light wave corresponding to a hologram, perform a Fourier transform on the third light wave, and split and output the Fourier-transformed third light wave.

Here, the first wavelength, the second wavelength, and the third wavelength may be different wavelengths. For example, the first wavelength may be a red wavelength, the second wavelength may be green, and the third wavelength may be a blue wavelength.

The first image providing apparatus 210 may include a first spatial light modulator 211, a first optical system 212 and 213, and a first beam splitting element 214. The first image providing apparatus 210 may output a light wave of the first wavelength. Since the first spatial light modulator 211, the first optical system 212 and 213, and the first beam splitting element 214 perform the same functions as the spatial light modulator 110, the optical system 120 and 130, and the beam splitting element 140 shown in FIG. 2, a detailed description thereof will be omitted.

The second image providing apparatus 220 may include a second spatial light modulator 221, a second optical system 222, 223, and a second beam splitting element 224. The second image providing apparatus 220 may output a light wave of the second wavelength. Since the second spatial light modulator 221, the second optical system 222, 223, and the second beam splitting element 224 perform the same functions as the spatial light modulator 110, the optical system 120, 130, and the beam splitting element 140 shown in FIG. 2, a detailed description thereof will be omitted.

The third image providing apparatus 230 may include a third spatial light modulator 231, a third optical system 232, 233, and a third beam splitting element 234. The third image providing apparatus 230 may output a light wave of the third wavelength. Since the third spatial light modulator 231, the third optical system 232, 233, and the third beam splitting element 234 perform the same functions as the spatial light modulator 110, the optical system 120, 130, and the beam splitting element 140 shown in FIG. 2, a detailed description thereof will be omitted.

The beam combining unit 240 may combine and output the first light wave output from the first image providing apparatus 210, the second light wave output from the second image providing apparatus 220, and the third light wave output from the third image providing apparatus 230.

The beam combining unit 240 may be implemented as a prism. For example, the beam combining unit 240 may be implemented as a trichroic prism or the like.

The beam combining unit 240 may be disposed adjacent to the beam splitting element of each of the first image providing apparatus 210, the second image providing apparatus 220, and the third image providing apparatus 230.

The holographic display apparatus 200 configured as described above may reconstruct a color image by outputting light using a beam splitting element optimized for each wavelength and combining the light of each wavelength using a trichroic prism or the like.

The holographic display apparatus and method for providing an enhanced viewing zone according to the present disclosure have an effect of providing a user with a large 3D image size, a wide viewing angle, and a wide viewing zone even with the limited spatial bandwidth of a spatial light modulator (SLM) by splitting a light wave using a beam splitting element.

The holographic display apparatus and method for providing an enhanced viewing zone according to the present disclosure have an effect of enabling effective correction of image distortion caused by chromatic aberration, alignment errors, or the like, by limiting the hologram display area of the spatial light modulator and shifting the position of the hologram display area, which makes it possible to achieve color viewing zone registration as well as avoid crosstalk due to viewing zone overlap.

The holographic display apparatus and method for providing an enhanced viewing zone according to the present disclosure have an effect of providing a user with superior visual quality and a realistic 3D visual experience, and maximizing the performance of the system through the efficient utilization of the optical structure.

While embodiments have been described with reference to the embodiments shown in the drawings, this is merely exemplary, and it will be understood by those skilled in the art that various modifications and other equivalent embodiments are possible therefrom. Therefore, the technical protection scope should be determined by the claims below.

What is claimed is:

1. A holographic display apparatus with an enhanced viewing zone, comprising:
a spatial light modulator configured to modulate light incident from a light source into a light wave corresponding to a hologram;
an optical system configured to perform a Fourier transform on the light wave from the spatial light modulator to generate a Fourier-transformed light wave; and
a beam splitting element configured to split the Fourier-transformed light wave propagated from the optical system to expand a viewing zone of a holographic display.

2. The holographic display apparatus of claim 1, wherein the optical system includes a first lens and a second lens,
wherein the first lens is positioned adjacently after the spatial light modulator in an optical path, and
wherein the second lens is positioned to be spaced apart from the first lens by a focal length of the first lens.

3. The holographic display apparatus of claim 2, wherein the beam splitting element is positioned adjacently after the second lens in the optical path.

4. The holographic display apparatus of claim 1, further comprising a processor configured to provide Computer-generated holography (CGH) data for representing the hologram to the spatial light modulator,
wherein the processor, based on a positional difference in the viewing zone caused by chromatic aberration of the beam splitting element, is configured to limit a hologram display area of the spatial light modulator or to adjust a position of the hologram display area.

5. The holographic display apparatus of claim 4, wherein the processor is configured to measure a light wave intensity for each local area of an entire viewing zone of the holographic display, and, based on the Fourier-transformed light wave intensity of each local area, to adjust brightness information of an input image for the generation of the hologram or to adjust an intensity of the light source during hologram display.

6. The holographic display apparatus of claim 4, further comprising a pupil tracking unit for tracking a position of a user's pupil,
wherein the processor, based on a size and position of the user's pupil tracked by the pupil tracking unit, is configured to limit the hologram display area of the spatial light modulator or to adjust the position of the hologram display area.

7. The holographic display apparatus of claim 6, wherein the processor is configured to infer an overlap area of a wavelength-specific viewing zone in the viewing zone of the holographic display, and to limit the hologram display area for each wavelength on the spatial light modulator corresponding to the overlap area.

8. A holographic display apparatus with an enhanced viewing zone, comprising:
a first image providing apparatus configured to modulate light of a first wavelength into a first light wave corresponding to a hologram, to perform a Fourier transform on the first light wave to generate a Fourier-transformed first light wave, to split the Fourier-transformed first light wave and to output the Fourier-transformed first light wave;
a second image providing apparatus configured to modulate light of a second wavelength into a second light wave corresponding to a hologram, to perform a Fourier transform on the second light wave to generate a Fourier-transformed second light wave, to split the Fourier-transformed second light wave, and to output the Fourier-transformed second light wave;
a third image providing apparatus configured to modulate light of a third wavelength into a third light wave corresponding to a hologram, to perform a Fourier transform on the third light wave to generate a Fourier-transformed third light wave, to split the Fourier-transformed third light wave, and to output the Fourier-transformed third light wave; and
a beam combining unit configured to combine and output the Fourier-transformed first light wave output from the first image providing apparatus, the Fourier-transformed second light wave output from the second image providing apparatus, and the Fourier-transformed third light wave output from the third image providing apparatus,
wherein the beam combining unit includes a trichroic prism, and
each of the first image providing apparatus, the second image providing apparatus, and the third image providing apparatus includes:
a spatial light modulator configured to modulate light emitted from a corresponding light source into a light wave corresponding to a hologram;
an optical system configured to perform a Fourier transform on the light wave from the spatial light modulator to generate a Fourier-transformed light wave; and
a beam splitting element configured to split the Fourier-transformed light wave propagated from the optical system to expand a viewing zone of the holographic display.

9. The holographic display apparatus of claim 8, wherein the beam combining unit is disposed adjacent to the beam splitting element of each of the first image providing apparatus, the second image providing apparatus, and the third image providing apparatus.
